(19) United States
(12) Patent Application Publication
(10) Pub. No.: US 2016/0268575 A1
(43) Pub. Date: Sep. 15, 2016

(54) BUSBAR AND BUSBAR MODULE

(71) Applicant: YAZAKI CORPORATION, Tokyo (JP)

(72) Inventors: Yoshiaki ICHIKAWA, Kakegawa-shi (JP); Hirotaka MUKASA, Kakegawa-shi (JP); Hirokuni KOIKE, Kakegawa-shi (JP)

(73) Assignee: YAZAKI CORPORATION, Tokyo (JP)

(21) Appl. No.: 15/163,827

(22) Filed: May 25, 2016

Related U.S. Application Data
(63) Continuation of application No. PCT/JP2014/084378, filed on Dec. 25, 2014.

(30) Foreign Application Priority Data
Dec. 25, 2013 (JP) 2013-267770

(51) Int. Cl. H01M 2/20; H01R 4/24; H01R 4/18; H01M 10/48

(52) U.S. Cl. CPC H01M 2/204; H01M 2/206; H01M 10/48; H01R 4/242; H01R 4/18

(57) ABSTRACT

Provided is a busbar including: a busbar main body made of a metal plate and transmits and receives power to/from a power supplying portion or a power consuming portion; and a connection portion configured to electrically connect the busbar main body to a voltage detecting wire. In the busbar, the connection portion is formed in the busbar main body so as to be electrically connected to the electric wire disposed in parallel along the busbar main body at a root side of a piece portion in such a manner that the piece portion is folded back from the root side of the piece portion. The piece portion is formed by cutting out and bending upward of a part of the metal plate.

### CROSS-REFERENCE TO RELATED APPLICATION

This application is a continuation application of International Application PCT/JP2014/084378, filed on Dec. 25, 2014, and designating the U.S., the entire contents of which are incorporated herein by reference.

### BACKGROUND OF THE INVENTION

1. Field of the Invention

The present invention relates to a busbar and a busbar module.

2. Description of the Related Art

Busbars have been used to transmit and receive power to/from a power supplying portion or a power consuming portion from the past. Electric wires are also connected to the busbars. For example, in recent year, electric wires (voltage detecting wires) used to detect a voltage of a power supplying portion or a power consuming portion are connected to busbars so as to safely and precisely control transmission and reception of power. As an example, there has been known a busbar and a busbar module disclosed in Japanese Laid-open Patent Publication No. 2011-210711 to be described below. The busbar and the busbar module are used for voltage detection of a battery cell in a battery module and will be described with reference to FIGS. 4 and 5.

FIG. 4 illustrates a busbar and a busbar module used for voltage detection of a battery module 120 as illustrated in FIG. 5. Here, reference numeral 101 indicates a busbar. The busbar 101 is formed of a metal such as copper which is excellent conductivity, and has substantially a rectangular shape. A coupling portion 102 made of a resin is fixed to a peripheral area of each of the busbars 101. The coupling portion 102 is used to couple the busbars 101 to each other such that the busbars 101 are adjacent to each other at a predetermined interval. The plurality of busbars 101 are arranged at predetermined intervals in a row. Each of the busbars 101 is provided with a terminal through-hole 103. Each of the busbars 101 is screwed with an electrode terminal 112 of each battery cell which has been inserted through each of the terminal through-holes 103, the battery cell being indicated by reference numeral 111 in FIG. 5. Accordingly, the busbar 101 and the electrode terminal 112 of the battery cell 111 are electrically connected to each other.

With the exception of being connected to the electrode terminal 112 of one battery cell 111 which is appropriately provided at an end, the busbars 101 are configured in such a manner that each busbar is connected to the electrode terminals 112 of two battery cells 111 such that the busbars 101 are shifted by a half pitch, thereby being connected to the electrode terminal 112 which is provided at rows facing each other in the battery module 120 as illustrated in FIG. 5, whereby a number of battery cells 111 are connected to each other in series to obtain high voltage.

A plurality of voltage detecting wires 104 are placed at an upper surface of the busbars 101 arranged in a row to detect a power supply voltage of each of the battery cells 111. Here, a plurality of conductor wires are accommodated in a flat cable and are used as the voltage detecting wires 104. Then, each of the voltage detecting wires 104 is electrically connected to one busbar 101 corresponding thereto by welding at a connection portion 105. In this way, one busbar module 110 is configured as a whole. A connector 106 is provided at one end of the voltage detecting wire 104. The connector 106 is connected to a connector (not illustrated) of a control device 113, and thus the control device 113 can monitor the voltage of each of the battery cells 111 and perform control of, for example, adjustment or cut-off of a current flowing through the battery module 120 depending on the monitored voltage.

In the above-described conventional busbar to which the electric wires such as the voltage detecting wires are connected, however, the busbar is electrically connected to the electric wires, which are provided on the busbar, by welding, and thus it was necessary to form an extra space in which the electric wires are place, in addition to an electrical conduction portion which was essentially required. For this reason, a large amount of metal such as copper, which is a material of the convention busbar, is consumed to cause an increase in cost, the weight of the busbar becomes heavier, and thus workability may be deteriorated when the battery module is mounted with the busbar, to which the electric wires are connected, that is, the busbar module.

In addition, a plate-like portion, which is a welding portion of the busbar, has low thermal resistance, whereas the conductor wire used as the voltage detecting wire has finely high thermal resistance in general. Thus, when the busbars are welded to the voltage detecting wires, respectively, it is difficult to satisfactorily weld both of them and a decrease in durability may be caused.

### SUMMARY OF THE INVENTION

It is an object of the present invention to provide a busbar and a busbar module in which a useless space is not required and thus, the consumption of metal such as copper is reduced, whereby workability is excellent at low costs. In addition, it is another object of the present invention to achieve a busbar and a busbar module which are highly reliable.

In order to achieve the above mentioned object, a busbar according to one aspect of the present invention includes a busbar main body made of a metal plate and used for transmitting and receiving power to/from a power supplying portion or a power consuming portion; and a connection portion configured to electrically connect the busbar main body to an electric wire. Herein, the connection portion is formed in the busbar main body so as to be electrically connected to the electric wire disposed in parallel along the busbar main body at a root side of a piece portion in such a manner that the piece portion is folded back from the root side of the piece portion. The piece portion is formed by cutting out and bending upward of a part of the metal plate.

According to another aspect of the present invention, the metal plate has substantially a rectangular shape, and the connection portion is formed in such a manner that a piece portion formed by an L-shaped cut is folded back at a root side of the piece portion, the L-shaped cut being provided in the metal plate.

According to still another aspect of the present invention, the metal plate has substantially a rectangular shape, and the connection portion is formed in such a manner that a piece portion surrounded by an U-shaped cut is folded back at a root side of the piece portion, the U-shaped cut being provided in the metal plate.

According to still another aspect of the present invention, the busbar main body is connected to an electrode terminal of a battery cell which constitutes a battery module.

Further, in order to achieve the above mentioned object, a busbar module according to one aspect of the present invention includes a busbar group in which the plurality of busbars according to any one of the above described are arranged at predetermined intervals in a row; a flat cable in which a plurality of conductor wires are accommodated, the plurality of conductor wires being disposed in parallel at predetermined intervals along a row direction of the plurality of busbars; and coupling portions provided along the row direction of the plurality of busbars and are fixed at side portions of the plurality of busbars adjacent to the flat cable, respectively, to couple the plurality of busbars to each other and to couple the plurality of busbars to the flat cable. Herein, each of the connection portions provided in the plurality of busbars is electrically connected to a predetermined one of the conductor wires in the flat cable.

According to another aspect of the present invention, the conductor wires are used as voltage detecting wires for detecting a voltage of a battery cell.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a busbar and a busbar module according to an embodiment of the present invention;

FIG. 2 is a top view of a battery module applied with the busbar and the busbar module illustrated in FIG. 1;

FIG. 3 is a perspective view of the battery module applied with the busbar and the busbar module illustrated in FIG. 1;

FIG. 4 is a perspective view of conventional busbar and busbar module; and

FIG. 5 is a perspective view of a battery module applied with the conventional busbar and busbar module illustrated in FIG. 4.

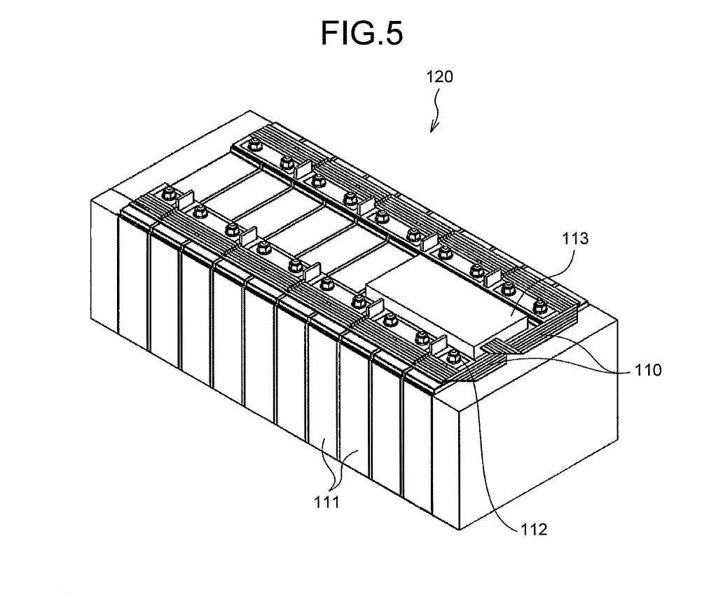

### DETAILED DESCRIPTION OF THE PREFERRED EMBODIMENTS

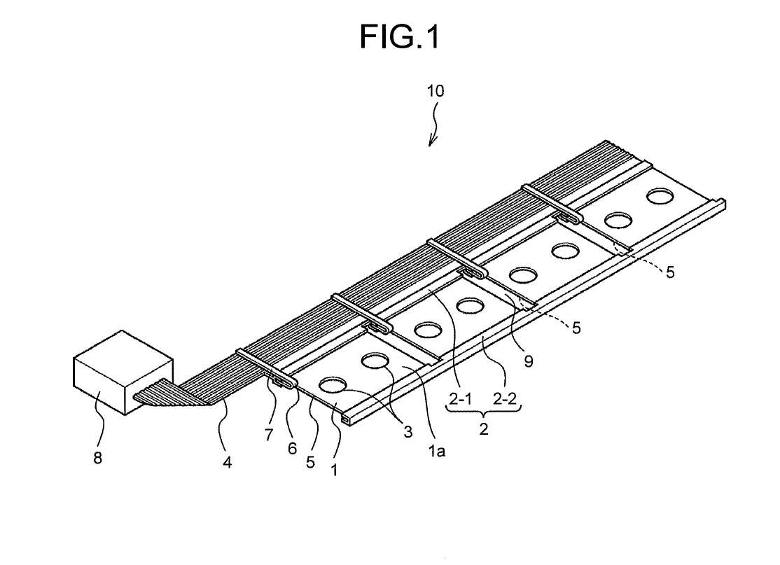

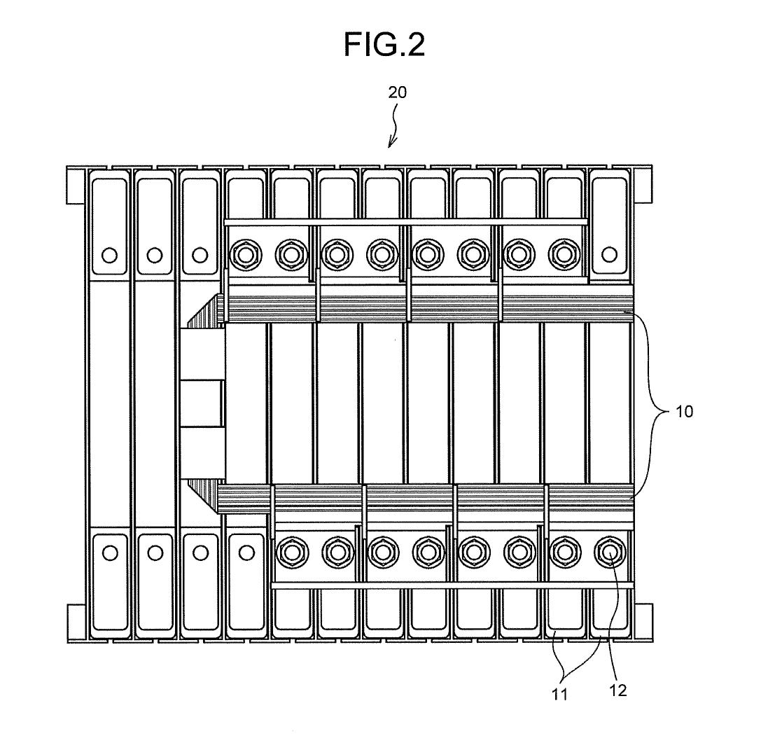

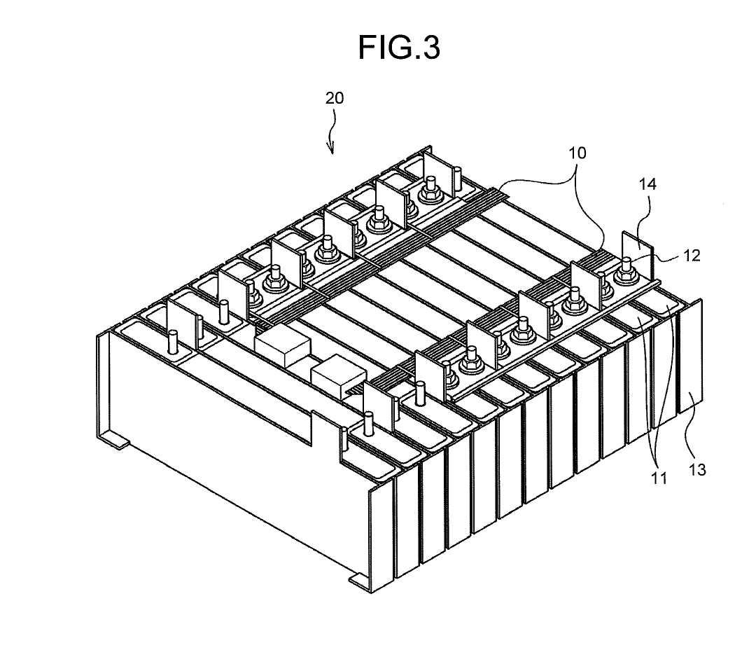

An embodiment of a busbar and a busbar module according to the invention will be described below with reference to the accompanying drawings. FIG. 1 illustrates a busbar and a busbar module for voltage detection used in a battery module. In addition, FIGS. 2 and 3 are a top view and a perspective view of the battery module applied with the busbar and the busbar module illustrated in FIG. 1, respectively.

In FIG. 1, reference numeral 1 indicates a busbar according to the present embodiment. The busbar 1 is formed of a substantially rectangular metal plate such as copper which has excellent conductivity. The busbars 1 are arranged at a predetermined interval in a row to form a busbar group. The plurality of busbars 1 are provided with coupling portions 2 (2-1 and 2-2) made of a resin along the row direction, respectively. The coupling portions 2 (2-1 and 2-2) are respectively fixed to side portions of the busbars 1 along the row direction. The busbar group has a structure in which the plurality of busbars 1 are coupled to each other at predetermined intervals by the coupling portions 2.

Each of the busbars 1 is mounted to a battery module 20 having a plurality of battery cells indicated by reference numeral 11 in FIGS. 2 and 3. The battery module 20 is configured in such a manner that the battery cells 11 are overlapped with each other in the same direction such that electrode terminals 12 are arranged in a row at one side of the battery cells 11 and electrode terminals 12 are arranged in a row at the other side thereof. For example, the battery module 20 is known in which positive electrode terminals and negative electrode terminals are alternately disposed in each row of the electrode terminals 12 or are disposed in parallel to have the same electrode. In the battery module 20, the electrode terminals 12 provided at one side of the plurality of predetermined battery cells are connected to each other by a connection member such as the busbar 1 such that the plurality of battery cells 11 are connected to each other in series or parallel. The connection member is to electrically connect the electrode terminals 12, which are formed in at least two battery cells continued to each other in the same direction in the plurality of battery cells overlapped with each other in the same direction, that is, the electrode terminals 12 arranged in the same direction, to each other. Specifically, a terminal through-hole 3 is provided in each of the busbars 1. Each of the busbars 1 is screwed with each of the electrode terminals 12 of each of the battery cells 11 which has been inserted through each of the terminal through-holes 3. Thus, the busbar 1 and the electrode terminal 12 of the battery cell 11 are electrically connected to each other.

With the exception of being connected to the electrode terminal 12 of one battery cell 11 which is appropriately provided at both ends in the overlapped direction of the battery cells 11 (which is not presented in FIGS. 1 to 3), the busbar 1 are configured in such a manner that each busbar is connected to the electrode terminals 12 of two battery cells 11 adjacent to each other such that the busbars 1 are shifted by a half pitch, thereby being connected to the electrode terminals 12 which are provided at rows facing each other in the battery module 20, as illustrated in FIGS. 2 and 3, whereby a number of battery cells 11 are connected to each other in series to obtain high voltage. The busbars to be connected to the electrode terminals 12 of the battery cells 11 provided at both ends in the overlapped direction of the battery cells 11 are connection members which are connected to a positive electrode terminal and a negative electrode terminal, respectively, which are disposed at both ends of the battery module 20.

In the present embodiment, the battery cells 11 are separated from each other by separators 13 made of a resin, and one partition portion 14 is provided at a position of the top surface of the separator 13 corresponding to the electrode terminal 12 (between the electrode terminals 12 adjacent to each other). The separators 13 are installed such that the partition portions 14 of the adjacent separators 13 have mutually different positions. By doing so, when the battery module 20 is mounted with the busbar 1, to which a voltage detecting wire 4 to be described below are connected, that is, a busbar module 10, the partition portion 14 is simply mounted to a gap portion 9 formed between the busbars 1 to penetrate therethrough, and thus the busbars 1 can be installed to be shifted by a half pitch, thereby being connected to the electrode terminals 12 which are provided at rows facing each other.

Electric wires are electrically connected to the busbar 1 according to the present embodiment. The electric wires can be used for transmission during charging and discharging and can be also used for confirmation of a battery state. In this illustration, as the electric wires for confirmation of the battery state, a plurality of voltage detecting wires 4 are installed to detect a power supply voltage of each battery cell 11. The shape or configuration of the voltage detecting wire 4 is not particularly limited, but the present embodiment has a configuration in which a plurality of conductor wires are accommodated in a flat cable to be used as the voltage detecting wires 4. In the flat cable, the plurality of conductor wires are disposed and accommodated in parallel at predetermined intervals along the row direction of the plurality of busbars 1. The plurality of conductor wires are accommodated inside the flat cable by being coated with a synthetic resin. The flat cable is provided along the row of the busbars 1 and is fixed to each of the busbars 1 through the coupling portion 2-1. The coupling portions 2-1 are fixed to side portions of the plurality of busbars 1 adjacent to the flat cable, respectively, and thus the plurality of busbars 1 are coupled to the flat cable. Here, one busbar module 10 is configured as a whole in this way.

In the present embodiment, a connector 8 is provided at one end of the voltage detecting wire 4, the connector 8 is connected to a connector of a control device (not illustrated), and thus the control device can monitor the voltage of each of the battery cells 11 and perform control of, for example, adjustment or cut-off of a current flowing through the battery module 20 depending on the monitored voltage.

In each of the busbars 1, a part of the substantially rectangular metal plate constituting a busbar main body la is cut out and bent upward to form a connection portion 7 at the busbar main body 1a. The end of the busbar 1 in the busbar group is provide with an L-shaped cut 5 formed in the metal plate and the connection portion 7 formed in such a manner that a portion (piece portion) formed by the cut 5 is folded back at a folded portion 6 of a root side. In addition, the connection portion 7 formed between the adjacent busbars 1 is formed in such a manner that the piece portion surrounded by the U-shaped cut 5 formed in the metal plate is folded back at the folded portion 6 of the root side of the piece portion. Each of these connection portions 7 is electrically connected to a predetermined one of the voltage detecting wires 4 corresponding thereto. Thus, the voltage of each of the busbars 1 can be detected by the voltage detecting wire 4. Although a method of connecting the connection portion 7 and the voltage detecting wire 4 to each other is not limited, the connection portion 7 and the voltage detecting wire 4 are electrically connected to each other by welding in the present embodiment. The U-shaped cut 5 is used to separate the adjacent busbars 1 from each other and the gap portion 9 is formed in such a manner that the piece portion surrounded by the cut 5 is folded back.

Although a method of manufacturing the busbar module 10 including the busbar 1, the coupling portion 2, and the voltage detecting wire 4 is not particularly limited, the busbar module 10 having the configuration illustrated in FIG. 1 is obtained in the present embodiment in such a manner that after the metal plate forming the busbar 1 by extrusion molding, the coupling portion 2, and the flat cable accommodating the plurality of conductor wires used as the voltage detecting wires 4 are integrally formed, the U-shaped cut having the gap portion 9 and the cut 5 is formed in the metal plate, and then the piece portion surrounded by the U-shaped cut is folded back at the root side of the piece portion to form the connection portion 7.

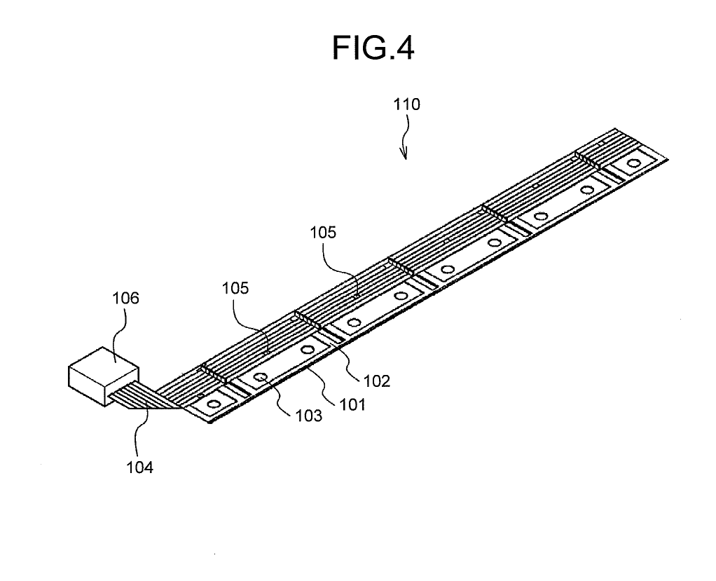

An operational effect of the present embodiment will be described below. According to the conventional busbar illustrated in FIG. 4, since the voltage detecting wires are placed on the upper surface of the busbar, it was necessary to form an extra space in which the voltage detecting wires are placed, in addition to an electrical conduction portion which was essentially required. In contrast, according to the busbar 1 of the present embodiment, it is sufficient to provide only an electrical conduction portion which is essentially required, and it is not necessary to form an extra space for the voltage detecting wires 4.

Therefore, since the consumption of metal such as copper, which is a material of the busbar 1, can be reduced, it is possible to reduce the cost, and since the weight of the busbar 1 becomes lighter, workability can be improved when the battery module 20 is mounted with the plurality of busbars 1, to which the voltage detecting wires 4 are connected, that is, the busbar module 10. In the present embodiment, furthermore, since the connection portion 7 is formed as described above, it is not necessary to separately prepare a member for connecting the busbar 1 and the voltage detecting wire 4 to each other, and costs can be further reduced.

Furthermore, according to the conventional busbar, it was necessary to weld the plat-like portion having low thermal resistance and the voltage detecting wire having high thermal resistance and it was difficult to satisfactorily weld both of them. In contrast, according to the present embodiment, since the welding portion of the busbar 1 is the connection portion 7, thermal resistance is higher than that of the plate-like portion, and thus the busbar 1 and the voltage detecting wire 4 can be satisfactorily welded to each other.

Therefore, according to the busbar 1 of the present embodiment, it is possible to maintain electrical connection with the voltage detecting wire 4 and to also maintain insulation properties by the resin which insulates the voltage detecting wire 4. For this reason, when the busbar 1 according to the present embodiment is used, it is possible to detect the voltage with high reliability. In addition, when the busbar module 10 is configured using the busbar 1 according to the present embodiment, the workability is good at low costs, and the busbar module can be provided with high reliability.

In a busbar and a busbar module according to the present invention, since an extra space is not required in which electric wires are placed on a busbar main body, the consumption of metal used as a material of the busbar main body can be reduced and the weight can be reduced, whereby it is possible to achieve low costs and improvement of workability. In addition, according to the busbar and the busbar module of the present invention, electrical connection with electric wires can be satisfactorily performed, and reliability can be improved. Furthermore, according to the busbar and the busbar module of the present invention, since it is not necessary to separately provide a member for connection with the electric wires, costs can be further reduced.

In addition, in the present embodiment, although the connection portions 7 provided in the busbars 1 have the same length, the connection portions 7 may have different lengths depending on the positions of the voltage detecting wires 4, which are connected to the busbars 1, respectively.

In addition, the plurality of conductor wires used as the voltage detecting wires 4 are accommodated in the flat cable in the present embodiment, but is not limited thereto. For example, each of voltage detecting wires 4 may be independently provided, and a plurality of flat cables may be provided in an overlapped form. In addition, the plurality of voltage detecting wires 4 are not necessarily required to be formed at only one side of the busbar 1, and may be configured to be formed at both sides of the busbar 1.

Furthermore, the busbar 1 and the busbar module 10 of the present embodiment are applied to the battery module 20, but it will be apparent to those skilled in the art that the busbar and the busbar module having the same structure can be generally applied to a busbar and a busbar module for voltage detecting wire connection which are used to transmit and receive power to/from a power supplying portion or a power consuming portion. In addition, the busbar 1 and the busbar module 10 of the present embodiment is provided with the terminal through-hole 3 for connection with the electrode terminal 12, but may be joined to the electrode terminal 12 by welding without providing such a hole. Furthermore, the shape of the busbar 1 is substantially rectangular in the present embodiment, but the busbar may have any shape.

In the present embodiment, furthermore, the connection portion 7 is configured in such a manner of being bent at appropriately 180°, but the bending angle is arbitrary. The connection portion may be configured to form perpendicularly to the busbar main body la by being bent at, for example, 90° and to connect the voltage detecting wire 4.

The embodiment of the present invention has been described in detail with reference to the accompanying drawings, but the embodiment is intended to be merely illustrative. The present invention is not limited to the above-described embodiment, and various changes, modifications, or the like can be made as appropriate. Moreover, the material, shape, dimensions, number, location, and the like of each constituent element in the above-described embodiment are optional and no limitations are imposed on them as long as the invention can be implemented.

What is claimed is:

1. A busbar comprising:
a busbar main body made of a metal plate and used for transmitting and receiving power to/from a power supplying portion or a power consuming portion; and
a connection portion configured to electrically connect the busbar main body to an electric wire, wherein
the connection portion is formed in the busbar main body so as to be electrically connected to the electric wire disposed in parallel along the busbar main body at a root side of a piece portion in such a manner that the piece portion is folded back from the root side of the piece portion. The piece portion is formed by cutting out and bending upward of a part of the metal plate.

2. The busbar according to claim 1, wherein
the metal plate has substantially a rectangular shape, and
the connection portion is formed in such a manner that a piece portion formed by an L-shaped cut is folded back at a root side of the piece portion, the L-shaped cut being provided in the metal plate.

3. The busbar according to claim 1, wherein
the metal plate has substantially a rectangular shape, and
the connection portion is formed in such a manner that a piece portion surrounded by an U-shaped cut is folded back at a root side of the piece portion, the U-shaped cut being provided in the metal plate.

4. The busbar according to claim 1, wherein the busbar main body is connected to an electrode terminal of a battery cell which constitutes a battery module.

5. The busbar according to claim 2, wherein the busbar main body is connected to an electrode terminal of a battery cell which constitutes a battery module.

6. The busbar according to claim 3, wherein the busbar main body is connected to an electrode terminal of a battery cell which constitutes a battery module.

7. A busbar module comprising:
a busbar group in which the plurality of busbars according to claim 1 are arranged at predetermined intervals in a row;
a flat cable in which a plurality of conductor wires are accommodated, the plurality of conductor wires being disposed in parallel at predetermined intervals along a row direction of the plurality of busbars; and
coupling portions provided along the row direction of the plurality of busbars and are fixed at side portions of the plurality of busbars adjacent to the flat cable, respectively, to couple the plurality of busbars to each other and to couple the plurality of busbars to the flat cable, wherein
each of the connection portions provided in the plurality of busbars is electrically connected to a predetermined one of the conductor wires in the flat cable.

8. A busbar module comprising:
a busbar group in which the plurality of busbars according to claim 2 are arranged at predetermined intervals in a row;
a flat cable in which a plurality of conductor wires are accommodated, the plurality of conductor wires being disposed in parallel at predetermined intervals along a row direction of the plurality of busbars; and
coupling portions provided along the row direction of the plurality of busbars and are fixed at side portions of the plurality of busbars adjacent to the flat cable, respectively, to couple the plurality of busbars to each other and to couple the plurality of busbars to the flat cable, wherein
each of the connection portions provided in the plurality of busbars is electrically connected to a predetermined one of the conductor wires in the flat cable.

9. A busbar module comprising:
a busbar group in which the plurality of busbars according to claim 3 are arranged at predetermined intervals in a row;
a flat cable in which a plurality of conductor wires are accommodated, the plurality of conductor wires being disposed in parallel at predetermined intervals along a row direction of the plurality of busbars; and
coupling portions provided along the row direction of the plurality of busbars and are fixed at side portions of the plurality of busbars adjacent to the flat cable, respectively, to couple the plurality of busbars to each other and to couple the plurality of busbars to the flat cable, wherein
each of the connection portions provided in the plurality of busbars is electrically connected to a predetermined one of the conductor wires in the flat cable.

10. A busbar module comprising:
a busbar group in which the plurality of busbars according to claim 4 are arranged at predetermined intervals in a row;
a flat cable in which a plurality of conductor wires are accommodated, the plurality of conductor wires being disposed in parallel at predetermined intervals along a row direction of the plurality of busbars; and
coupling portions provided along the row direction of the plurality of busbars and are fixed at side portions of the plurality of busbars adjacent to the flat cable, respectively, to couple the plurality of busbars to each other and to couple the plurality of busbars to the flat cable, wherein
each of the connection portions provided in the plurality of busbars is electrically connected to a predetermined one of the conductor wires in the flat cable.

11. The busbar module according to claim 7, wherein
the conductor wires are used as voltage detecting wires for detecting a voltage of a battery cell.
